(19) United States
(12) Patent Application Publication
(10) Pub. No.: US 2026/0119973 A1
(43) Pub. Date: Apr. 30, 2026

(54) Collective Charging Control for Mobile Computing Devices

(71) Applicant: Zebra Technologies Corporation, Lincolnshire, IL (US)

(72) Inventors: Ajay Sood, Bangalore (IN); Bijosh Thykkoottathil, Holtsville, NY (US); Vatsal Parasrampuria, Lake Grove, NY (US); Prasanna Sreedharan, Bangalore (IN)

(73) Assignee: Zebra Technologies Corporation, Lincolnshire, IL (US)

(21) Appl. No.: 18/932,570

(22) Filed: Oct. 30, 2024

(51) Int. Cl. G06N 20/00; G05B 19/042

(52) U.S. Cl. CPC G06N 20/00; G05B 19/042; G05B 2219/2639

(57) ABSTRACT

A method includes: obtaining forecasting data based on historical indications of energy consumed by each of a set of mobile computing devices during a plurality of time periods; obtaining a future time period; based on the forecasting data, generating (i) a time within the future time period corresponding to an expected deployment of the mobile computing devices, and (ii) a target charge level corresponding to the time, the target charge level corresponding to an expected energy demand at the mobile computing devices following the expected deployment; generating configuration data including the time and the target charge level; and transmitting the configuration data to each of the plurality of mobile computing devices to control charging of respective batteries of the mobile computing devices.

### BACKGROUND

Mobile computing devices, such as portable computers, barcode scanners, and the like, include rechargeable batteries that can power the components of such devices while in use. The batteries may degrade over time, e.g., such that the maximum energy storage capacity of the batteries decreases. Certain factors can accelerate battery degradation, such as time spent at a full charge. For example, a battery that spends extended periods of time at a full charge may degrade faster than a battery that spends less time at a full charge.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a system for collective charging control for mobile computing devices.

FIG. 2A is a diagram illustrating certain internal components of a mobile computing device in the system of FIG. 1.

FIG. 2B is a diagram illustrating certain internal components of the server of FIG. 1.

FIG. 3 is a flowchart of a method of generating configuration data for collective charging control.

FIG. 4 is a diagram illustrating an example performance of blocks 305 and 310 of the method of FIG. 3.

FIG. 5 is a diagram illustrating an example performance of block 320 to 330 of the method of FIG. 3.

FIG. 6 is a flowchart of a method of charging control for mobile computing devices.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Examples disclosed herein are directed to a method, comprising: obtaining forecasting data based on historical indications of energy consumed by each of a set of mobile computing devices during a plurality of time periods; obtaining a future time period; based on the forecasting data, determining (i) a time within the future time period corresponding to an expected deployment of each of the set of mobile computing devices, and (ii) a target charge level corresponding to the time, the target charge level corresponding to an expected energy demand at each of the set of mobile computing devices following the expected deployment; generating configuration data including the time and the target charge level; and transmitting the configuration data to each of the set of mobile computing devices to control charging of respective batteries of each of the set of mobile computing devices.

Additional examples disclosed herein are directed to a computing device, comprising: a communications interface; and a processor configured to: obtain forecasting data based on historical indications of energy consumed by each of a set of mobile computing devices during a plurality of time periods; obtain a future time period; based on the forecasting data, determine (i) a time within the future time period corresponding to an expected deployment of each of the set of mobile computing devices, and (ii) a target charge level corresponding to the time, the target charge level corresponding to an expected energy demand at each of the set of mobile computing devices following the expected deployment; generate configuration data including the time and the target charge level; and transmit the configuration data to each of the set of mobile computing devices to control charging of respective batteries of each of the set of mobile computing devices.

Further examples disclosed herein are directed to a computing device, comprising: a battery; a communications interface; and a processor configured to: receive, via the communications interface, configuration data including a time corresponding to an expected deployment of the computing device, and a target charge level corresponding to an expected energy demand at the computing device following the expected deployment; determine that the computing device has been connected with a charger; and control charging of the battery to reach the target charge level before the time.

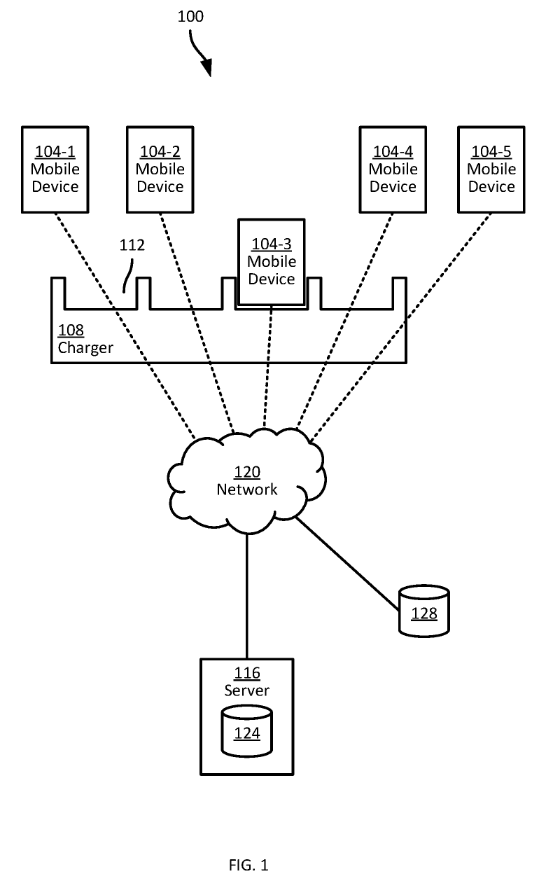

FIG. 1 illustrates a system 100 for collective charging control for mobile computing devices. The system 100 includes a plurality of mobile computing devices 104-1, 104-2, 104-3, 104-4, and 104-5, which are also collectively referred to herein as mobile computing devices 104 or devices 104, and generically as a mobile computing device 104 or a device 104. The devices 104 can be of various types, including any one of, or any combination of, mobile computers (e.g., with handheld form factors, wearable form factors, or the like), tablet computers, barcode scanners, mobile printers, and the like. The devices 104 can be deployed in a wide variety of environments, including transport and logistics facilities (e.g., warehouses, airport cargo facilities, and the like), manufacturing facilities, and the like. The system 100 can include other numbers of devices 104 than the five shown in FIG. 1. For example, a given facility may include hundreds or thousands of devices.

The devices 104 can be deployed in a facility to perform any of a variety of operations, including for example barcode scanning or other data capture, e.g., to support picking operations in a shipping facility. The devices 104 may be deployed in one or more pools, e.g., for a given activity in the facility, a given area of the facility, or the like. For example, the devices 104 (or a set of the total number of devices 104 in the facility) can be disposed in one or more staging areas, for retrieval by staff at the facility and use during the above-mentioned operations. Devices 104 may be retrieved at the beginning of a time period such as a shift, e.g., by a plurality of workers assigned to that shift. The devices 104 may then be returned to the staging area(s) at the end of the shift, e.g., for use by the staff (or other staff) during a later shift. A given device 104 may be selected for use by any of a wide variety of staff members at the facility. That is, there may not be any specific associations between devices 104 and staff members.

Each device 104 can be powered by a rechargeable battery, e.g., a lithium-ion battery (other battery chemistries can also be employed, however). The devices 104 can be connected to one or more chargers 108 when not in use. The charger 108 can be disposed in the staging area mentioned above, in some examples. The charger 108 includes a plurality of cradles 112 each configured to receive a device 104 (as shown with the device 104-3 in FIG. 1) and connect a port or other electrical contact of the device 104 with a power supply of the charger 108. Various other forms of the charger 108 can also be provided in other examples, including cables configured to plug into the devices 104, chargers 108 with single cradles (e.g., rather than a charger 108 that can accommodate multiple devices 104 as shown in FIG. 1), and the like.

As will be apparent, when a device 104 is removed from a cradle 112 (or otherwise disconnected from charging infrastructure in the facility), e.g., at the start of a shift or other period of deployment in the facility, the device 104 may be in use for several hours without an external power supply. If the battery of the device 104 does not have sufficient energy stored to power the device 104 during the deployment period, operations involving the device 104 (e.g., the picking operations mentioned above) may be interrupted to charge the device 104, or to retrieve another device 104 during the deployment period. Such interruptions are costly and inefficient. In some facilities, devices such as the devices 104 are therefore configured to charge their batteries substantially to a full state of charge as frequently and/or as quickly as possible. Maintaining a full state of charge reduces the risk that a battery will store too little energy to sustain operations during an entire deployment period.

To maintain a full state of charge as often as possible, however, the devices 104 may opportunistically charge their batteries (e.g., as early and as quickly as charging is available). As a result, a device 104 may charge its battery during periods of time when the available electricity (e.g., from a grid to which the charger 108 is connected) has a higher carbon intensity (e.g., at times when electricity generation is more reliant on non-renewable sources), increasing the environmental impact of charging.

Maintaining a full charge can also contribute to degradation of the battery, which can reduce the maximum capacity of the battery over time. That is, the more time a rechargeable battery spends at a full charge, the more rapidly the battery may degrade. Over time, the performance of a battery may degrade sufficiently to prevent the battery from powering the device 104 for a complete deployment period without charging. The batteries of the devices 104 may be replaced periodically, but replacing a battery incurs a cost, and may temporarily remove a device 104 from the pool of available devices 104.

To mitigate the degradation of battery performance resulting from time spent at a full charge, the devices 104 can be configured to charge their batteries to a target charge level below a full charge, and/or to reach the target charge level close to the expected deployment time. To mitigate the environmental impact of charging, the devices 104 can be configured to charge their batteries during time periods with lower carbon intensity associated with the generation of electricity supplied to the facility.

Selecting a target charge level lower than a full charge, while remaining sufficient to power the devices 104 for a full shift presents various technical difficulties. Those technical difficulties may be compounded by charging at time periods with low carbon intensity. For example, the target charge level may vary depending on the type of device (e.g., with some devices 104 having higher battery capacities than others, and therefore able to function with lower target charge levels). The target charge level may also change over time, e.g., with seasonal variations in operations at the facility or other time-dependent environmental conditions. The devices 104 may also be re-assigned to different areas of the facility, to perform different functions with different power demands, or the like. As a result, configuring target charge levels for each device 104 manually, e.g., on a per-device basis, may be an intractable task, particularly in facilities housing and utilizing hundreds or thousands of devices.

When a target charge level has been selected, there may be further technical obstacles to timing the charging activity of the devices 104, e.g., to preferentially charge during periods with lower carbon intensity. For example, the time at which a device 104 may be removed from the charger 108 for use may vary from day to day, e.g., depending on which of two or more daily shifts the device 104 is used for. Manually configuring such start times in each of hundreds or thousands of devices 104 is highly costly and impractical. Some mobile devices may track historical usage patterns to detect time periods that are likely available for charging (e.g., during which the mobile device is unlikely to be disconnected from a charger for use). Performing such tracking and analysis by each device 104, however, imposes an additional computational load on each of the potentially large pool of devices 104 in the facility. Further, such per-device tracking may suffer from slow convergence and low accuracy, as a result of a small amount of sample data (e.g., the activity of that particular device 104 alone).

As described below, components of the system 100 implement functionality to collect deployment data from the devices 104 corresponding to deployment timing and energy use at the devices 104. Components of the system 100 further aggregate the collected data to generate and/or update forecasting data that represents trends in the collected data. The forecasting data can then be used to predict energy demands for future deployments of the devices 104, as well as times at which the devices 104 are expected to be deployed (e.g., at which the devices 104 are likely to be disconnected from the charger 108). Based on the forecasted expected energy demands and deployment times, the devices 104 can be provided with configuration data that each device 104 can use for charging control. The configuration data can indicate when the device 104 is expected to be disconnected from the charger 108, and what charge level is expected to be sufficient to power the device 104 throughout the next deployment. The determination of such configuration data is performed in the system 100 on an aggregate basis, and therefore mitigates additional computational burden on individual devices 104, while improving the accuracy of the resulting configuration data.

The system 100 includes a server 116, e.g., connected with the devices 104 via a network 120 (e.g., any one of, or any combination of, local area networks and wide area networks, and/or short-range networks including peer-to-peer connections such as Bluetooth, near-field communication, and the like). The server 116 is configured to receive the deployment data mentioned above from the devices 104, e.g., for preprocessing and/or storage in a repository 124. In other examples, the charger 108 can collect the deployment data and relay the deployment data to the server 116. The server 116 is further configured to generate and/or update a forecasting model using the deployment data. Using the forecasting model, the server 116 is configured to generate one or more configuration files (or any other suitable data structure containing configuration data) for transmission to the devices 104. The configuration files indicate a future time when the devices 104 are expected to be deployed, and a target charge level corresponding to that future time. The target charge level corresponds to an expected energy demand at the devices 104 following the expected deployment. The server 116 can also incorporate carbon intensity data for certain future time periods, e.g., obtained from a data source 128 via the network 120. The source 128 can be maintained by an electrical grid operator, for example. The devices 104 are configured to control charging of their respective batteries to reach the target charge level at or before the expected deployment time. When carbon intensity data is available in the configuration data, the devices 104 can also be configured to preferentially charge their batteries during time periods that minimize the emissions-related impacts of charging.

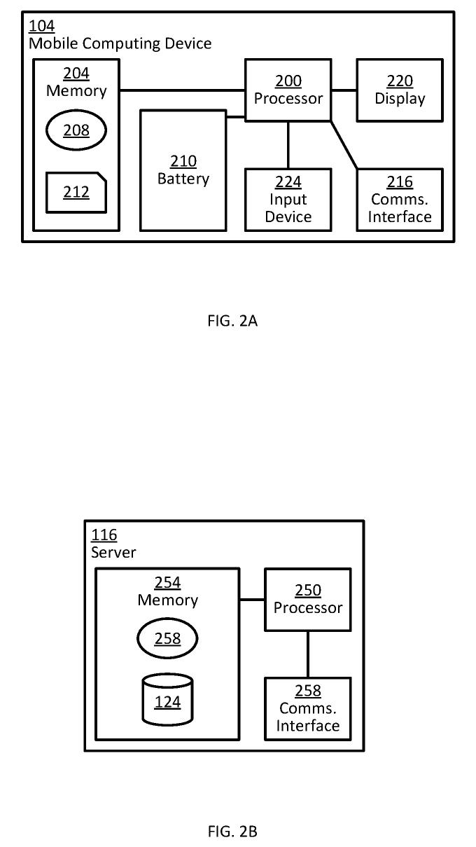

Turning to FIGS. 2A and 2B, before discussing the functionality of the devices 104 and the server 116, certain internal components of the devices 104 and the server 116 are discussed. FIG. 2A illustrates internal components of a device 104. Although the devices 104 may have various form factors and specific instances of the components shown in FIG. 2A, each device 104 includes a functional equivalent to the components shown in FIG. 2A.

The device 104 includes a processor 200, such as a central processing unit (CPU), graphics processing unit (GPU), application-specific integrated circuit (ASIC), or the like. The processor 200 is communicatively coupled with a non-transitory computer-readable storage medium such as a memory 204, e.g., a combination of volatile memory elements (e.g., random access memory (RAM)) and non-volatile memory elements (e.g., flash memory or the like). The memory 204 stores a plurality of computer-readable instructions in the form of applications, including in the illustrated example a charge control application 208, whose execution by the processor 200 configures the device 104 to collect and report deployment data to the server 116, as well as to control charging of a battery 210 of the device 104, e.g., based at least in part on configuration data 212 received from the server 116 (also shown stored in the memory 204). In some examples, the functionality outlined above in association with the application 208 can be implemented by two or more applications. For example, the collection and reporting of deployment data can be implemented by a first application, and the control of charging of the battery 210 can be implemented by a second application. In some examples, the battery 210 can include a charge controller, e.g., a microcontroller configured to manage charging rates and active charging times for the battery 210. In such examples, the configuration data 212 can be provided to the charge controller.

The device 104 also includes a communications interface 216, enabling the device 104 to communicate with other computing devices, including the server 116, e.g., via the network 120. The device 104 can also include one or more output devices, such as a display 220, and one or more input devices 224, such as a touch screen, sensors (e.g., a camera, a barcode scanning assembly, and/or other inputs) or the like.

FIG. 2B illustrates internal components of the server 116. The server 116 includes a processor 250, such as a central processing unit (CPU), graphics processing unit (GPU), application-specific integrated circuit (ASIC), or the like. The processor 250 is communicatively coupled with a non-transitory computer-readable storage medium such as a memory 254, e.g., a combination of volatile memory elements (e.g., random access memory (RAM)) and non-volatile memory elements (e.g., flash memory or the like). The memory 254 stores a plurality of computer-readable instructions in the form of applications, including in the illustrated example a charge control forecasting application 258, whose execution by the processor 250 configures the server 116 to generate and/or update a forecasting model based on deployment data received from the devices 104. The server 116 is further configured, based on the forecasting model, to generate forecast energy demand and deployment times for the devices 104, and to generate the configuration data 212 for transmission to the devices 104. The memory 254 can also store, as shown in FIG. 2B, the repository 124 of deployment data (e.g., raw deployment data as received from the devices 104 and/or processed deployment data).

The server 116 also includes a communications interface 258, enabling the server 116 to communicate with other computing devices, including the devices 104, e.g., via the network 120. The server 116 can be implemented as a single physical computing device. In other examples, the server 116 can be implemented in a distributed manner, e.g., with one or more networked physical computing devices being logically associated to implement the functionality described below in connection with the server 116.

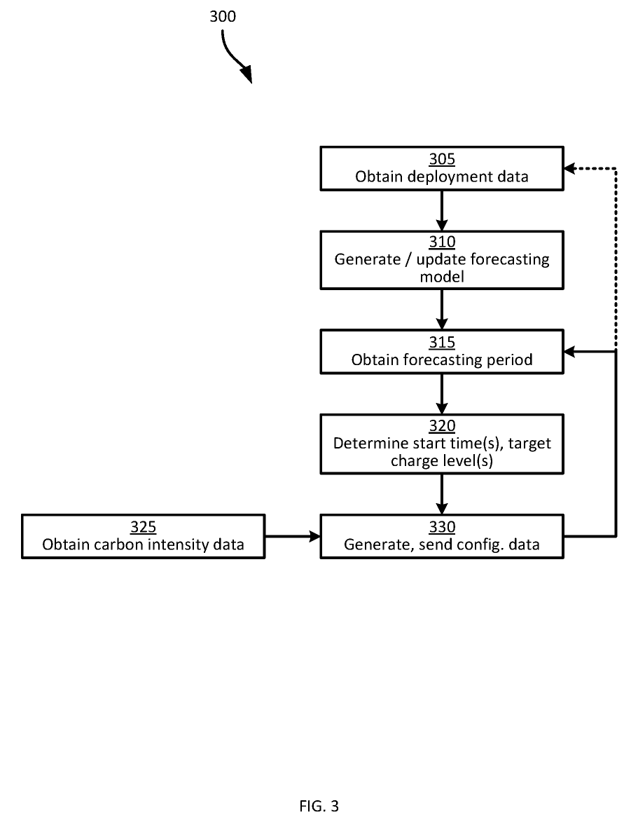

Turning to FIG. 3, a method 300 of generating configuration data for collective charging control is illustrated. The method 300 is described below in conjunction with its performance at the server 116, e.g., via execution of the application 258 by the processor 250.

At block 305, the server 116 is configured to obtain data from the devices 104, containing indications of energy consumed at the devices 104 during deployment time periods, e.g., shifts in the facility in which the devices 104 are deployed. The data obtained at block 305 can also be referred to as deployment data. The devices 104 can be configured to transmit deployment data to the server 116, e.g., according to a predetermined frequency, and/or in response to certain events. For example, the devices 104 can be configured to transmit deployment data to the server 116 in response to either or both of being connected to the charger 108, and being removed from the charger 108.

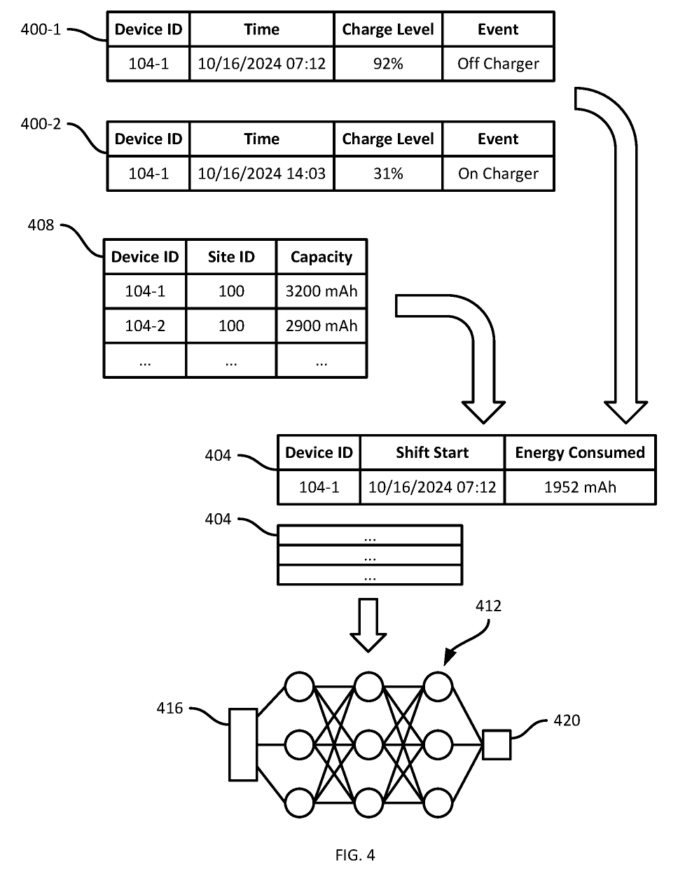

The data obtained by the server 116 at block 305 contains historical indications of energy consumed by the devices 104 during various time periods. Turning to FIG. 4, examples of the data obtained at block 305 are illustrated. As shown in FIG. 4, the server 116 can receive, e.g., from the device 104-1, a first record 400-1, which the device 104-1 may transmit in response to being removed from the charger 108. In other words, the device 104-1 may transmit the record 400-1 in response to a deployment (e.g., the start of a shift). The record 400-1 includes an identifier of the device 104 (e.g., a serial number, media access control (MAC) address, or the like), as well as a timestamp indicating the date and time the record 400-1 was generated. The record 400-1 also includes a charge level (e.g., 92% in this example) of the battery 210 of the device 104-1 at the time the record 400-1 was generated. The record 400-1 also includes, in this example, an event identifier, e.g., indicating that the record 400-1 was generated in response to removal of the device 104-1 from the charger 108.

FIG. 4 also illustrates a second record 400-2, e.g., transmitted by the device 104-1 in response to placement of the device 104-1 back onto the charger 108 at a later time (e.g., the end of the shift that began when the record 400-1 was generated). As will be apparent from FIG. 4, the timestamps of the records 400-1 and 400-2 indicate a time period (e.g., between 7:12 am and 2:03 pm on October 16, 2024). The record 400-1 indicates a charge level of the battery 210 at the start of the time period, and the record 400-2 indicates a charge level of the battery 210 at the end of the time period.

The server 116 can be configured, in response to receiving the second record 400-1, to generate an aggregated deployment record 404 that identifies a time period, e.g., in the form of a “shift start” time. The record 404 can also identify the end of the shift in some examples, e.g., using the timestamp from the record 400-2. The record 404 further includes an amount of energy consumed during the time period, which can be determined from the charge levels in the records 400-1 and 400-2. The server 116 can, for example, maintain device profiles 408 in the memory 254 that include attributes for each device 104. In the illustrated example, the device attributes include device identifiers, an identifier of a site (e.g., a facility, area within a facility, or the like) in which the device 104 is deployed, and a battery capacity of the device 104. The profiles 408 can contain various other information, including for example a type of the device (e.g., a manufacturer, a model number, or the like).

The server can determine the amount of energy consumed indicated in the record 404 based on the charge levels from the records 400-1 and 400-2, and the battery capacity from the profile data 408 corresponding to the device 104-1. In some examples, the profile data 408 can be updated periodically to reflect changes in battery capacity, e.g., due to battery degradation. For example, the devices 104 can periodically report to the server 116 a battery health metric indicative of a current maximum energy storage capacity of the battery 210.

The server 116 is configured to obtain a plurality of records 404, e.g., including multiple records from each device 104. For example, the deployment data obtained at block 305 can include a plurality of records 400, with each pair of records corresponding to one shift, from each device 104.

Returning to FIG. 3, at block 310 the server 116 is configured to generate or update a forecasting model, which may also be referred to as forecasting data, based on the deployment data obtained at block 305. The forecasting data can be a time series forecasting model, generated via a suitable time series analysis algorithm (e.g., Long Short-Term Memory (LSTM), autoregressive recurrent neural networks or other suitable recurrent neural networks, Seasonal Autoregressive Integrated Moving Average (SARIMA), or the like). Other mechanims for generating the forecasting model can also be employed, e.g., other deep learning algorithms (including supervised and unsupervised mechanisms), and the like. For example, the server 116 can be configured to train a forecasting model 412 such as a recurrent neural network (e.g., including an input layer 416, a plurality of hidden or internal layers, and an output layer 420) using a plurality of records 404, from a plurality of the devices 104, representing a plurality of historical shift start times and measured energy consumption amounts. The forecasting model 412 may accept as input, for example, a window of input data in the form of records 404, e.g., covering a predefined time period leading up to a current time.

The model 412 can be configured to generate forecasted future values for one or more expected shift start times and corresponding energy demands. In other words, the model 412 is a representation of trends in the historical data obtained at block 305. Such trends may include seasonal variations in deployment times and energy consumption levels, intra-day variations (e.g., between morning shifts and evening shifts), variations in deployment times and energy consumption over the course of a week, and the like.

In some examples, the server 116 can generate a plurality of models 412, e.g., for respective facilities, for respective device types within a given facility, for respective regions of a facility, and the like. In other examples, the model 412 can be configured to generate distinct forecast data, e.g., for each of a plurality of device types represented in the deployment data 305. The provision of distinct models corresponding to respective device types, for example, may improve the accuracy of forecast data for each device type. Certain device types, for example, may consume more or less energy performing a given function, e.g., capturing and processing an image, or the like. Deploying distinct models for each device type may permit each model to more accurately forecast the energy use of the corresponding device type. Further, the training and execution of each model may be simplified, relative to a model that covers multiple device types. The storage and processing requirements of the models may therefore be reduced.

At block 315, the server 116 is configured to obtain a forecasting period. The forecasting period is a future time period for which the server 116 will generate expected deployment time(s) and target charge levels. The server 116 can be configured to automatically select a forecasting period 315, e.g., according to a predetermined future time period stored in the memory 254. The future time period can, for example, extend from a current time to one day in the future. A wide variety of other future time periods can also be obtained at block 315. For example, the server 116 can be configured to receive input data specifying a future time period (e.g., a 48-hour period beginning one week in the future).

At block 320, the server 116 is configured to determine a time within the forecasting period. The determined time corresponds to an expected deployment of the mobile computing devices 104, e.g., associated with the start of a shift in the facility. That is, the determined time is a time at which the devices 104 are likely to be disconnected from the charger 108. The server 116 is also configured to determine a target charge level corresponding to the time. The target charge level corresponds to an expected energy demand at the mobile computing devices 104 following the expected deployment (at the start time).

At block 325, the server 116 can also be configured to obtain carbon intensity data for each of a plurality of sub-periods in the forecasting period. The carbon intensity data can include, for each sub-period, an indication of the degree to which the generation of electricity supplied to the facility containing the devices 104 is forecasted to be reliant on non-renewable energy sources. The sub-periods can each have a length of one hour, for example (although various other sub-period lengths are also contemplated). The carbon intensity data can be generated by the entity managing the data source 128. To obtain the carbon intensity data, the server 116 can be configured to transmit a request to the data source 128, e.g., for any sub-periods within the forecasting period from block 315. In other examples, the performance of block 325 can be omitted.

At block 330, the server 116 is configured to generate configuration data based on the determined start time and target charge level from block 320, and based on the carbon intensity data from block 325, when block 325 is performed. The configuration data includes the time forecast at block 320, and the target charge level forecasted at block 320. The configuration data can further include the carbon intensity data obtained at block 325.

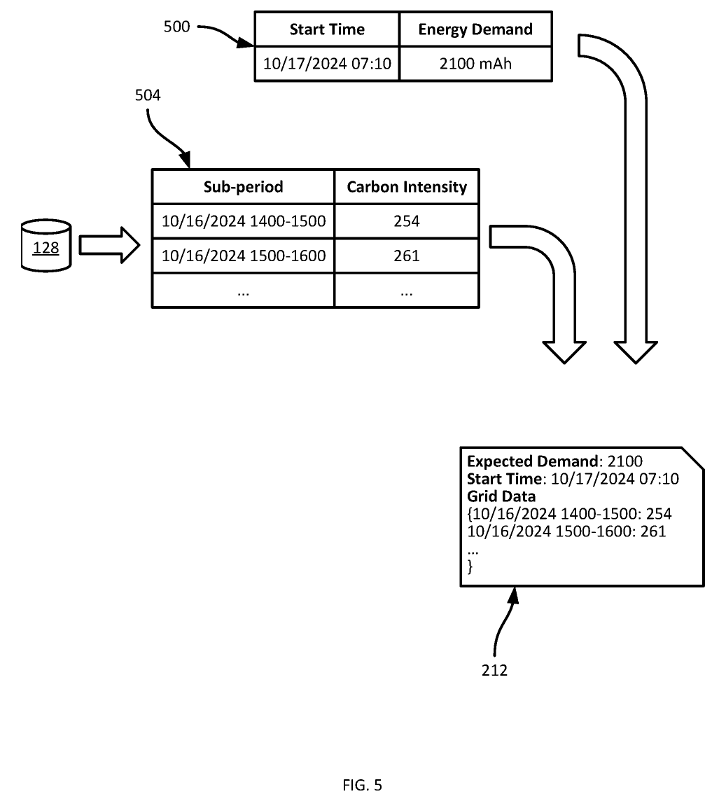

Turning to FIG. 5, example forecast data 500 is shown, as generated at block 320. The forecast data 500 includes an expected deployment time (e.g., 7:10 am on October 17, 2024), and an expected energy demand. The expected energy demand is shown in mAh, but can also be expressed as a percent (e.g., a state of charge of the battery 210). FIG. 5 also illustrates carbon intensity data 504, e.g., obtained from the data source 128 at block 325. The data 504 includes hourly carbon intensity scores for the forecasting period, e.g., the period of 24 hours beginning at the end of the shift represented in the record 400-2. The server 116 is configured, at block 330, to generate the configuration data 212 by combining the forecast data 500 with the carbon intensity data 504. In some examples, the server 116 can convert the energy demand from the forecast data 500 to a percentage or other relative indication of charge level (e.g., based on the profile data 408). In other examples, as shown in FIG. 5, the target charge level in the configuration data 212 can be the forecasted energy demand.

The server 116 is configured to transmit the configuration data 212 to each of the devices 104, e.g., via the network 120. Each device 104, in other words, may receive and store the same configuration data 212. In some examples, the configuration data 212 can include start times and/or target charge levels for each of multiple device types. In other examples, the server 116 can generate more than one version of configuration data, e.g., for distinct types of devices 104 in a set of devices at a facility. In such examples, the server 116 can send a given version of configuration data to the devices 104 of the corresponding type. Certain device types, as noted previously, may consume more or less energy performing a given function. In further examples, some device types may be more likely to be deployed earlier or later than other device types. Deploying distinct configuration data for each device type may permit the configuration data to more accurately account for operational variations between device types.

Returning briefly to FIG. 3, after generating and transmitting the configuration data at block 330, the server 116 is configured to return to block 315, e.g., to perform a further forecast (e.g., a day later). In some examples, the server 116 can return to block 305 after at least some performances of block 330, to receive additional deployment data and optionally update (e.g., re-train) the model 412.

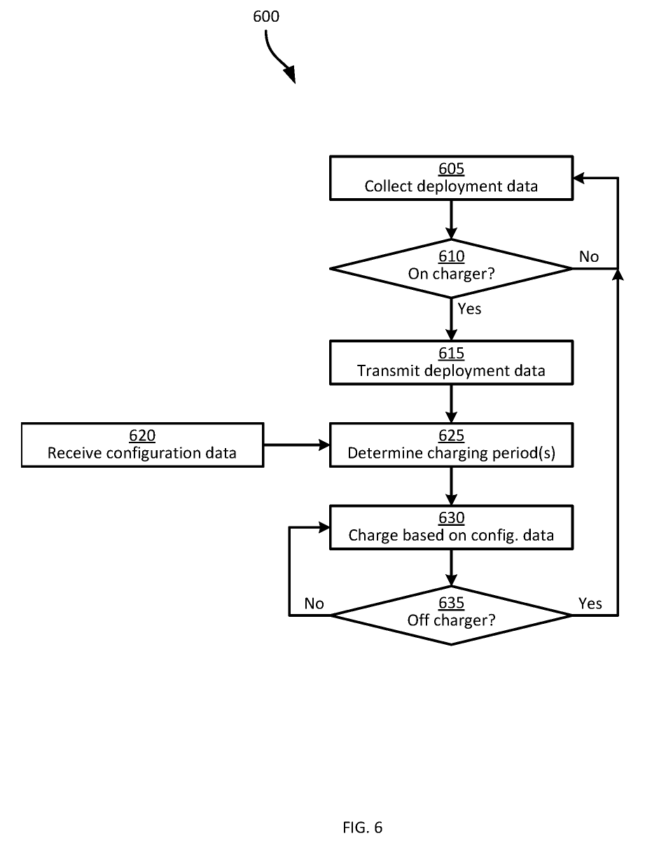

Turning to FIG. 6, a method 600 of charging control at the devices 104 is illustrated. The method 600 is described below in conjunction with its performance at a device 104, e.g., via execution of the application 208 by the processor 200. Each device 104 in the system 100 can perform the method 600.

At block 605, the device 104 can be configured to collect deployment data, such as the data contained in the records 400 described in connection with FIG. 4. The device 104 can be configured to determine, at block 610, whether the device 104 is connected with the charger 108. When the determination at block 610 is negative, the device 104 can continue collecting deployment data and monitoring for a charging event. When the determination at block 610 is affirmative, indicating that the device 104 has been placed on the charger 108, the device 104 can be configured to transmit deployment data to the server 116 at block 615, e.g., in the form of a record 400-2 (corresponding to an “on charger” event).

At block 620, the device 104 can be configured to receive the configuration data 212 from the server 116. In some examples, the device 104 has previously received configuration data 212 that remains valid (e.g., at least one start time in the configuration data 212 is in the future), and the performance of block 620 can be omitted. At block 625, the device 104 is configured to determine one or more charging periods. When the configuration data 212 does not include carbon intensity data, at block 625 the charging period can be any portion of, up to and including the entirety of, the time remaining between a current time and the start time in the configuration data 212.

When the configuration data 212 includes carbon intensity data, the device 104 can be configured to determine charging periods at block 625 by selecting the sub-period defined in the configuration data 212 that has the lowest carbon intensity value. The device 104 can then determine whether the target charge level in the configuration data 212 can be reached within the selected sub-period. If that determination is affirmative, the device 104 can proceed to block 630. If that determination is negative, the device 104 can select the sub-period with the next-lowest carbon intensity value. The above process can be repeated until the device 104 has selected sufficient sub-periods to permit the device 104 to charge the battery 210 to the target charge level.

At block 630, the device 104 is configured to charge the battery 210 according to the configuration data 212, e.g., charging at any suitable charging rate during the selected sub-period(s), until the target charge level is reached. When the target charge level is reached, the device 104 can be configured to cease charging the battery 210.

At block 635, the device 104 is configured to determine whether it has been removed from the charger 108. When the determination at block 635 is negative, the device 104 returns to block 630. When the determination at block 635 is affirmative, the device 104 can return to block 605, e.g., to collect and/or transmit deployment data as described above.

As will be understood from the discussion above, performance of the method 300 by the server 116, along with performance of the method 600 by the devices 104, provides various technical improvements to the devices 104. The generation of a centralized forecasting model at the server 116, using data reported from a plurality of devices 104, may permit the determination of target charge levels and corresponding start times for the devices 104, where setting such values may otherwise (in the absence of the forecasting functionality performed by the server 116) be prohibitively costly. The deployment of the configuration data to the devices 104 may also increase the lifespan of the batteries 210.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
obtaining forecasting data based on historical indications of energy consumed by each of a set of mobile computing devices during a plurality of time periods;
obtaining a future time period;
based on the forecasting data, determining (i) a time within the future time period corresponding to an expected deployment of each of the set of mobile computing devices, and (ii) a target charge level corresponding to the time, the target charge level corresponding to an expected energy demand at each of the set of mobile computing devices following the expected deployment;
generating configuration data including the time and the target charge level; and
transmitting the configuration data to each of the set of mobile computing devices to control charging of respective batteries of each of the set of mobile computing devices.

2. The method of claim 1, wherein obtaining the forecasting data includes:
obtaining, for each of the set of mobile computing devices, a record including:
a first one of the time periods,
an initial battery charge level of the mobile computing device corresponding to a start of the first time period, and
a final battery charge level of the mobile computing device corresponding to an end of the first time period; and
generating the forecasting data based on the records.

3. The method of claim 2, wherein generating the forecasting data includes: training a forecasting model based on the records.

4. The method of claim 2, further comprising:
generating, from the initial battery charge level and the final battery charge level, an amount of energy consumed by the mobile computing device during the first time period; and
generating the forecasting data based on the amount of energy consumed.

5. The method of claim 1, further comprising:
obtaining carbon intensity data for each of a plurality of sub-periods in the future time period; wherein the configuration data includes the carbon intensity data.

6. The method of claim 1, further comprising:
obtaining respective sets of forecasting data corresponding to each of a plurality of types of the mobile computing devices.

7. The method of claim 6, further comprising:
generating respective times and target charge levels based on each set of forecasting data.

8. A computing device, comprising:
a communications interface; and
a processor configured to:
obtain forecasting data based on historical indications of energy consumed by each of a set of mobile computing devices during a plurality of time periods;
obtain a future time period;
based on the forecasting data, determine (i) a time within the future time period corresponding to an expected deployment of each of the set of mobile computing devices, and (ii) a target charge level corresponding to the time, the target charge level corresponding to an expected energy demand at each of the set of mobile computing devices following the expected deployment;
generate configuration data including the time and the target charge level; and
transmit the configuration data to each of the set of mobile computing devices to control charging of respective batteries of each of the set of mobile computing devices.

9. The computing device of claim 8, wherein the processor is configured to obtain the forecasting data by:
obtaining, for each of the set of mobile computing devices, a record including:
a first one of the time periods,
an initial battery charge level of the mobile computing device corresponding to a start of the first time period, and
a final battery charge level of the mobile computing device corresponding to an end of the first time period; and
generating the forecasting data based on the records.

10. The computing device of claim 9, wherein the processor is configured to generate the forecasting data by: training a forecasting model based on the records.

11. The computing device of claim 9, wherein the processor is configured to:
generate, from the initial battery charge level and the final battery charge level, an amount of energy consumed by the mobile computing device during the first time period; and
generate the forecasting data based on the amount of energy consumed.

12. The computing device of claim 8, wherein the processor is configured to:
obtain carbon intensity data for each of a plurality of sub-periods in the future time period; wherein the configuration data includes the carbon intensity data.

13. The computing device of claim 8, wherein the processor is configured to:
obtain respective sets of forecasting data corresponding to each of a plurality of types of the set of mobile computing devices.

14. The computing device of claim 13, wherein the processor is configured to:
generate respective times and target charge levels based on each set of forecasting data.

15. A computing device, comprising:
a battery;
a communications interface; and
a processor configured to:
receive, via the communications interface, configuration data including a time corresponding to an expected deployment of the computing device, and a target charge level corresponding to an expected energy demand at the computing device following the expected deployment;
determine that the computing device has been connected with a charger; and
control charging of the battery to reach the target charge level before the time.

16. The computing device of claim 15, wherein the configuration data includes carbon intensity levels for a plurality of sub-periods; and wherein the processor is configured to control charging of the battery by:
selecting the one of the sub-periods with the lowest carbon intensity level; and
charging the battery during the selected sub-period.

17. The computing device of claim 15, wherein the processor is configured to receive the configuration data from a server.

18. The computing device of claim 15, wherein the processor is further configured to:
collect deployment data including:
a time period,
an initial battery charge level of the computing device corresponding to a start of the time period, and
a final battery charge level of the computing device corresponding to an end of the time period; and
transmit the deployment data to a server.
